(19) United States
(12) Patent Application Publication
(10) Pub. No.: US 2006/0020930 A1
(43) Pub. Date: Jan. 26, 2006

(54) System and method of identifying source code associated with a displayed component

(75) Inventor: Gilad Hemi, Raanana (IL)

Correspondence Address: PEARL COHEN ZEDEK, LLP, 10 ROCKEFELLER PLAZA, SUITE 1001, NEW YORK, NY, 10020, US

(73) Assignee: Press - Sense Ltd.

(21) Appl. No.: 11/187,924

(22) Filed: Jul. 25, 2005

Related U.S. Application Data
(60) Provisional application No. 60/590,433, filed on Jul. 23, 2004.

(51) Int. Cl. G06F 9/45

(52) U.S. Cl. 717/136; 717/106; 717/118

(57) ABSTRACT

A system and method of finding instructions or source code that control a component shown on a display. In some embodiments, a user may select a graphic component shown on a display. A processor may for example identify an executable code that is associated with or that generates or controls such component, and may derive a name, address or other designation of an instruction or source code file that generated such executable code or file. In some embodiments, a source code file may be opened in an environment that supports editing of such source code.

### CROSS REFERENCE TO RELATED APPLICATIONS

This application claims priority from U.S. Provisional Patent Application 60/590,433, filed on Jul. 23, 2004 and entitled Graphic User Interface (GUI) Component Class Source Code Editing, which is incorporated by reference herein in its entirety.

### FIELD OF THE INVENTION

The invention is in the field of source code identification in general, and editing source code that yields a graphic user interface (GUI) in particular.

### BACKGROUND OF THE INVENTION

A GUI may include one or more components that may be included in a framework that may organize and contain components, such as graphic areas shown on a screen, monitor, cathode ray tube or other display. A software application that may generate or yield one or more parts or sections of a GUI may include one or more GUI component instances or permutations relating to such component. The software application may include one or more component class source code files (CCSCF) depositories that may store for example source code files of typically tens and possibly even hundreds of GUI component classes and logical flow component classes. Some of such files may be editable by for example a programmer or developer who may have access to such source code. A software application may also include a component class runtime file (CCRF) depository for storing runtime files or executable code that may be generated by or yielded upon the execution of a related source code file. The CCSCF depository and the CCRF depository may share files where runtime files are editable, such as for example, when the source code files do not require compilation for execution. A software application may also include a registry for storing names of GUI component classes and their corresponding GUI component class runtime files, and also their GUI component type. Such a registry may be included in a code base of for example a software application, and may be updated for example before a software application is executed or compiled. A display screen position table may store names of GUI component instances that appear at a particular time on a display. Such a table may be generated in run time, for example as the components appear on a display. Such a table may include the GUI component class names of the code that generates the component, the GUI component types, the positions of the components on the screen, and the parent GUI component instances if any.

### SUMMARY OF INVENTION

Embodiments of the invention include a system having a processor to receive a signal that identifies a component shown on a display and to identify a file that contains source code that may control or generate such component. In some embodiments, the processor may open the file and display an editable version of the source code. In some embodiments, the component may be selected or identified by a user who may cause a signal to be generated by for example a pointing device. In some embodiments a processor may access a designation of another file that may include executable code that may have been generated by the source code. In some embodiments, a processor may change a designation or address of for example a file containing executable code into a designation or address of a file containing source code that generated such executable code. In some embodiments, the change may include changing a prefix, a suffix or a link in such address. In some embodiments a processor may search a code base for such designation or address of an executable file or source code file. In some embodiments, a search may be conducted of a table that may store addresses or designations of files that are associated with or that control one or more components shown on a display. In some embodiments a computer may identify a source code file that is associated with a parent of the component. In some embodiments, a processor may store a source code file in a directory and may store an executable code file in the same or a related directory. In some embodiments, a processor may freeze a view of one or more components that are shown on a display, and may show a selection or menu on the display. The menu may enable for example a user to choose to open a source code file controlling an instance of a component and/or to open a source code file that controls a parent of the component.

In some embodiments. the invention may include a method of receiving an electronic signal from for example a pointing device that indicates a selection of a component shown on a display, and opening an editable version of source code that controls the shown and selected component. In some embodiments, the method may include identifying another file that may include executable code generated by the source code. In some embodiments a processor may alter a link of an address of an executable file to derive an address of a source code file that generated such executable file.

In some embodiments, the invention may include an article such as a storage medium, having stored thereon instructions, that when executed, result in opening a file having an editable version of source code that generates a component shown on a display. A processor may open the file in response to a selection by a user of a component shown on a display.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may be understood by reference to the following detailed description when read with the accompanied drawings in which:

FIG. 1 is a schematic diagram of a display with components of a graphic user interface in accordance with an embodiment of the invention;

FIG. 2 is a block diagram of a method in accordance with an embodiment of the invention; and

FIG. 3 is a block diagram of a method of locating a source code file in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “processing,” “computing,” “calculating,” “determining,” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. For example, while the term display as used in this application may refer to for example a computer screen or monitor, such term may also refer to other electronic display devices such as television sets, video games consoles, phone screens or personal digital assistant screens. Furthermore, while the term source code as used in this application may refer to for example readable and editable code, such term may also refer any one or more instructions executable on an electronic device.

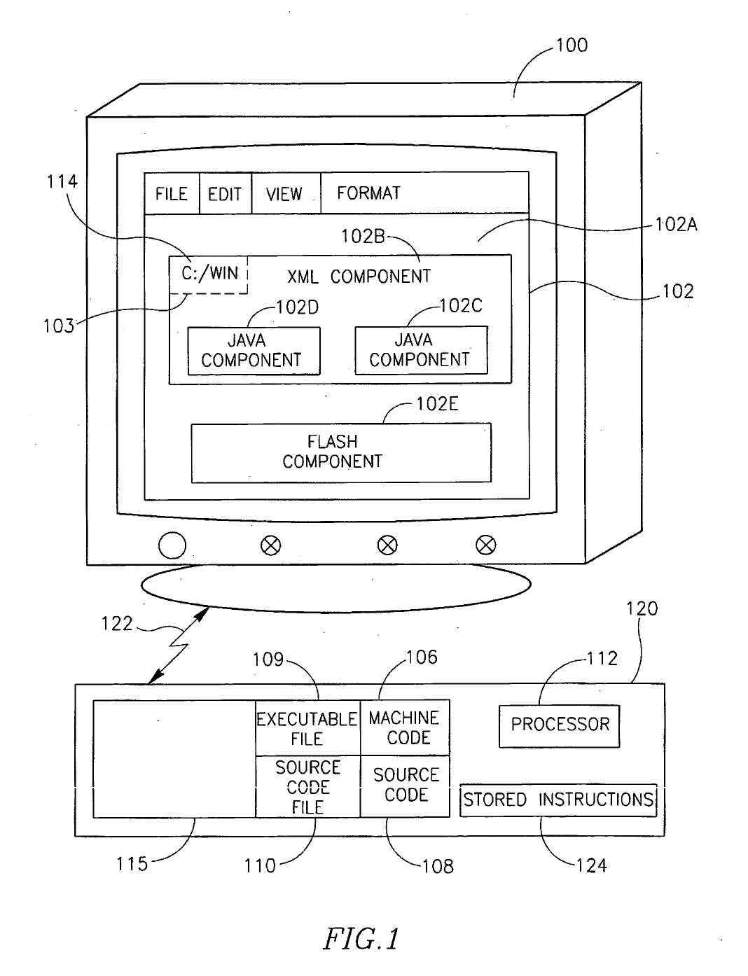

Reference is made to FIG. 1, a schematic diagram of a display with components of a GUI in accordance with an embodiment of the invention. In some embodiments, display 100 may be or include a computer screen or monitor such as for example a cathode ray tube, flat screen, large panel, plasma or other electric or electronic display of information. Other types of displays 100 or monitors may be used. In some embodiments, the information, symbols, graphics or pictures shown on display 100 may be linked to, connected to or otherwise subject to commands, signals or instructions generated by for example code or commands that may be stored or formatted in a machine readable fornat, such as for example executable code or machine code 106. In some embodiments, a particular collection of codes may generate, create or control a particular segment or component 102 of an area shown on a display 100 at a particular time. In some embodiments an executable code or machine code 106 that may control a component 102 may be generated by the execution or compilation of readable or editable instructions such as for example source code 108. In some embodiments one or more tags 103 that may point to, link, designate or provide an address of a collection of, or file containing, executable code that may generate, control or create one or more components 102 shown on a display 100, may be loaded into for example a registry, table or other data storage area or memory 115 of a computer or display 100 when such components 102 are shown on such display 100. In some embodiments the components 102 shown on display 100 at any time may be represented by tags 103 that were loaded into and stored in a registry or in a look up table. In some embodiments, a tag 103 may be or include a designation of a file such as for example a class name, an address or other link to an executable file 109 or a source code file 110.

In operation, and in some embodiments of the invention, a display 100 may, upon for example, an instruction from a user of computer 120, show a class name, address, link, tag 103 or other designation that points to or is otherwise associated with for example one or more executable files 109 that may include machine code 106. Such machine code 106 may control or generate component 102. Upon for example an instruction from a user, or in some embodiments, automatically, such class name, address, link, tag 103 or other designation may be converted, translated or otherwise altered to generate or show for example an address, link, tag 103 or other designation of a source code file 110 or other collection of readable or editable instructions that may have generated the machine code 106 in executable file 109. In some embodiments, a source code file 110 controlling a component 102 may be shown or opened upon for example an instruction received from a user who may for example point to or otherwise designate or select a component 102 shown on display 100. In some embodiments a source code file 110 may be opened in a readable and/or editable format such as for example in a development environment that supports encoding of such source code 108. In some embodiments, a user may for example use a cursor or other pointing or selection device to select a component 102 shown on a display 100, and may for example click on such component 102 or on a class name, address, link, tag 103 or other designation associated with such component 102 to open or gain access to the source code 108 or source code file 110 that controls such component 102.

In some embodiments, a class name, address, link, tag 103 or other designation of for example an executable file 109 or a source code file 110 may for example initially not be shown on display 100. In some embodiments tag 103 may not be shown on display 100 at all or may be shown temporarily. In some embodiments, a user or other activator of an application who may wish for example to gain access to a readable or editable instruction such as source code 108, may cause a signal to be generated or may make a selection by for example clicking a mouse button when a cursor is on a component 102. Such signal or selection may in an embodiment of the invention cause file tags 103 to be shown on a display 100. In some embodiments, class name, address, link, tag 103 or other designations of for example an executable file 109 that may have been stored or loaded in a memory 115, such as for example in a look up table, may then be shown on display 100. In some embodiments a user may give an instruction to for example freeze the position or other view of components 102 shown on a display 100, and such instruction or a further signal or instruction may show a class name, address, link, tag 103 or other designation of one or more of files that control or generate the components 102 that are then shown on display 100. In some embodiments, a user may issue a signal such as for example by clicking a mouse button on a tag 103 or on a display, icon or other symbol or handle 114 that is on or near a component 102, and may thereby generate an instruction to for example a processor 112 to open a source code file 110 or other collection of instructions that may control or generate such component 102.

In some embodiments, an address, designation or tag 103 of a file may be shown or represented with a handle 114, an icon or other symbol such as for example an arrow ⇑ or →. A user may click on or otherwise point to or select such handle 114 or icon that may be for example near or contiguous to a shown component 102. A processor 112 that may process one or more instructions may for example find a source code 108 or source code file 10 that may be associated with or that may generate such component 102. In some embodiments a class name, address, link, tag 103 or other designation for a source code file 110 or executable file 109 that may control or generate a component 102 may be shown when for example a user passes a cursor over such component 102. In some embodiments, a class name, address, link, tag 103 or other designation associated with an executable file 109 may be shown during for example an initial state when for example a cursor is passed over for example a component 102 or a handle 114 of a component 102. In some embodiments, a class name, address, link, tag 103 or other designation to for example a source code 108 or source code file 110 may be generated, derived or calculated from for example a class name, address, link, tag 103 or other designation of an executable file 109 when for example a user clicks on or otherwise signals or instructs for example a processor 112 to for example open or access a source code 108 that may be associated with or that may have yielded or generated an machine code 106 that controls such component 102.

In some embodiments, a readable and/or editable code such as for example HTML or JAVA may be executable without compilation into executable code or machine code 106. A tag 103 may in such or other embodiments designate, link to, point to or be associated with a file or other collection of instructions that may include such code.

In some embodiments, a display 100 may show a menu of for example one or more arrows ⇑ or → or other symbols, and a user may select or otherwise issue an instruction for, for example a processor 112, to identify, locate and open the source code file 110 for a selected component 102, and/or to identify, locate and open the code for a parent component 102. A user may for example desire to edit or alter a particular instance of a component 102 rather than all instances of a component 102, and such alteration may be made in a file that contains such parent source code 108.

In some embodiments, an application of the invention may upon a signal 122 or instruction from a user, such as upon a click of a mouse or other selecting device that selects a component 102 shown on a display, open a source code file 110 or otherwise access a readable and/or editable instruction in for example a development environment that may support editing, changing or otherwise altering the accessed instructons, source code 108 or source code file 110. For example, a source code file 110 that includes Java instructions may be opened along with a Java development environment, and such development environment may facilitate a user to alter or amend the source code 108 that may be included in such accessed or opened file 110. Other development environments that may run or be associated with code in an accessed or opened file 110 may be initiated or opened when such file 110 is opened. In some embodiments, a folder that may contain a source code file may be opened. In some embodiments a link to a source code file 110 may be presented or displayed to a user without opening a source code file 110.

In some embodiments, an application of the invention may find, designate, locate or identify a source code file 110 that is associated with or that yields a particular machine code 106 or executable file 109 by altering, changing or amending a class name, address, link, tag 103 or other designation of such executable file 109. For example, if a tag 103 indicates a Java GUI component type, an application of the invention may determine the GUI source code file 110 location directly from the GUI component class name. For example, in the case of a Java component instance 102D having a GUI component class name iway.login.applet1, the location of its originating GUI source code file 110 may be for example codebase/src/iway/login/applet1.Java. This source code file 110 locating technique may also be applicable to other computer languages and technologies such as HTML, Jscript, VBscript, and the like.

In a further example, if an invoked handle's 114 class name, address, link, tag 103 or other designation indicates a Flash GUI component type, a processor 112 executing instructions of an embodiment of the invention may determine the GUI component class runtime or executable file 109 name or address from the GUI component name and may find the corresponding originating GUI source code file 110 which may be in the same directory as the GUI component class runtime or executable file 109. For example, in the case of Flash component 102E having a GUI component 102 class name of for example http://server/flash.swf, the name of its associated runtime or executable file 109 may be codebase/flash.swf. The name, address or designation of the associated originating GUI source code file 110 may be codebase/flash.fla. In some embodiments, an executable file 109 may be stored in a folder other than the folder in which its associated source code file 110 is stored. This source code file 110 locating technique may also be also applicable to other computer languages and technologies such as C++, Visual Basic, and the like.

In some embodiments, the alteration or translation of a class name, address, link, tag 103 or other designation of an executable file 109 into an address for an associated source code file 110 may entail altering a suffix, prefix or some other address link of the executable file 109 address. Such an alteration may involve changing a .swf suffix into a .fla suffix, or changing an ‘http:// server’ link of an address into a codebase link of an address. Other methods of changing a designation or altering an address are possible.

In yet another example, if an invoked handle's 114 class name, address, link, tag 103 or other designation indicates a XML GUI component type, an application of the invention may determine the component 102 class runtime file name from the entry of the component 102 as may have been loaded and stored in display screen position table, a look up table or in another position in a memory 115 at the time for example that the component was shown on the display 100, or before the time that the component was shown on display 100. In such case, the descriptive code file or source code file 110 to be opened may be the same as the associated executable file 109. For example, in the case of XML component 102B instance having a GUI component class name layoutB, the name of its GUI runtime file and therefore its GUI source code file 110 may be codebase\layouts\.xml. This source code file 110 locating or derivation technique that may be based on a name, address or designation of an executable file 109 name may also be applicable to other computer languages and technologies such as scriplets, descriptive data including databases, text files, and the like.

Other methods may be used to derive or locate a source code file 110 that may be associated with a particular executable file 109 or with a particular component 102. For example, in some embodiments, a search of some or all of a code base of a software package or application may be used to find a class name, address, link, tag 103 or other designation of an executable file 109 when, for example such executable file is declared, created, generated or otherwise accessed in a source code file 110. In some embodiments a search of the code base may be conducted for, for example, a string that includes the name of a component, as an indication of the name of an associated source code file 100. For example, if a component name includes xxx.yyy, a search of a code base may be conducted for a string such as for example “prodig=’xxx.yyy’. In such an example a search may not be conducted for an executable file 109.

In some embodiments, display 100 may show or display one or more components 102 such as for example graphical components of for example a GUI, man-machine interface, video clip, animation figure, photograph, diagram, drawing or other displayed or portrayed item that may be visible or otherwise identifiable on for example display 100. In some embodiments a component 102 may be or include one or more dialog boxes, menu lists or other visible manifestations by which a viewer or user of a display 100 may for example respond to or interface with an application such as for example a software application. For example in some embodiments a component 102 may be or include a display of an XML component 102B that may graphically display an entry in a database such as for example a product available in a catalogue or products. In some embodiments, a component may be or include a Java component 102C and 102D, a Flash component 102E or graphic components 102 that may be generated by one or more other functions, instructions or commands or in one or more development environments. For example, in some embodiments, a component 102 may be or include one or more icons, figures or characters in an animation screen or movie or video clip. In some embodiments, a component 102 may be or include a portion of an Internet page that may include for example pictures, texts or links to other pages. Other types or classes of components 102 may be used.

Embodiments of the invention may be stored as instructions 124 on for example a storage media such as for example a disk, hard drive, or other memory or mass storage components, and such instructions, when executed may perform an embodiment of the invention.

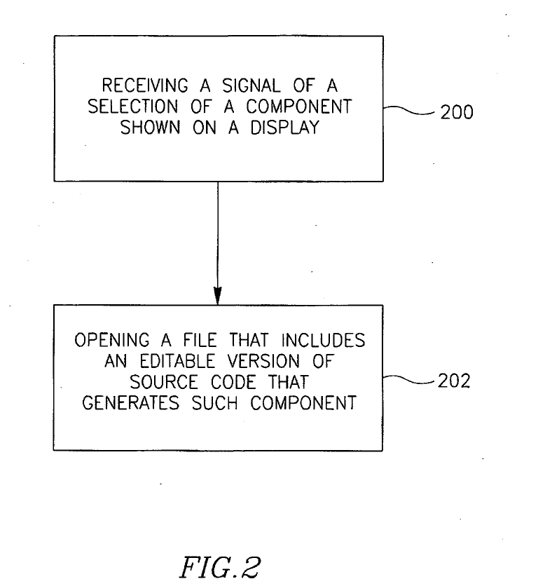

Reference is made to FIG. 2, a block diagram of a method in accordance with an embodiment of the invention. In block 200, and in some embodiments, a component of a computer such as for example a processor may receive a signal, such as for example a signal from a cursor pointing device or other input device such as a keyboard or electronic pointing device. Such signal may indicate a selection of one or more components that may at a particular time be shown on a display connected to such computer. In block 202, a computer or for example a processor may locate and open a file or other collection of instructions that may include an editable version of source code that may control or generate one or more graphic functions of such component. In some embodiments, a computer or for example a processor, may identify a class name, address, link, tag or other designation of another file that may include executable code that may have been generated by the source code, and such executable code may control or generate the component shown on the display. In some embodiments, a name, address, link or other designation of an executable file may be altered or changed in accordance with pre-determined rules as part of a process of deriving a name, address or other designation of the source code file from which the executable file was generated. For example, a prefix, suffix or other portion of an address of an executable file may be changed to yield an address or designation of its associate source code file.

In some embodiments, a computer or for example a processor, may freeze the components shown on a display, and may show for example a menu or other selection of options or choices by which a user or other activator may make for example a first choice to open a file that may include source code that controls a component, and/or a second choice to open a file that includes source code of a parent of the component.

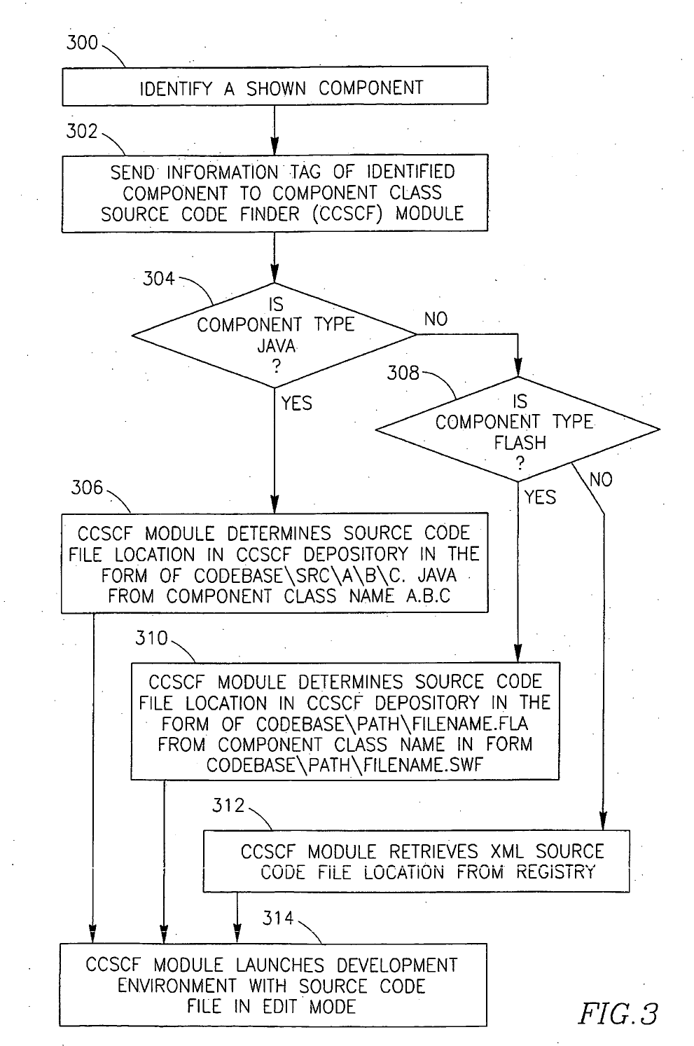

Reference is made to FIG. 3, a block diagram of a method of locating a source code file of a shown component in accordance with an embodiment of the invention. In block 300, a signal indicating an identification of a component shown on a display, may be received by for example a processor. In some embodiments, the signal may have been generated by a user of a software application who may point to a component then shown on a display. Such pointing may be done with a mouse or other cursor pointing device. The method may then proceed to block 302.

In block 302, data in a tag that is associated with a shown component may be sent to for example a CCSCF module or other set of instructions. The data may include for example a designation or address of for example an executable file that may control or generate an identified component. Other data may be included. The data may have been included in for example a look up table or a registry of executable files that control displayed components.

In block 304, a determination may be made as to whether for example a class name of the identified component is a Java application. If the identified component is associated with a Java application, the method may continue in block 306. If the identified component is not associated with a Java application, the method may continue to block 308. In block 306, an instruction such as a software instruction in a CCSCF module may determine a location of a source code file that is associated with the executable file. In some embodiments a suffix such as java may be added to a designation or address of the executable file.

Returning to block 308, a determination may be made as to whether for example a class name of the identified component is a flash class type. If the identified component is associated with a flash class type, the method may proceed to block 308. If the identified component is not associated with a flash class type, the method may continue to block 312.

In block 310, an instruction such as a software instruction in a CCSCF module may determine a location of a source code file that is associated with the executable file that generates the identified component. In some embodiments a suffix such as .swf of the address of such executable file may be altered to a suffix such as .fla, which may be or correspond to an address of a source code file associated with the executable file that generated the identified component.

Returning to block 308, if the component is not associated with a flash class type, the component may be associated with an XML class type. The method may then proceed to block 312, where an instruction may retrieve the XML source code file from the registry or look up table that may store files that control or generate shown components.

In embodiments of the invention, blocks 306, 310 and 312 may proceed to block 314, where for example a processor or an instruction in the CCSCF module may launch or open a development environment in which one or more of the identified source code files may be edited, and may open an editable version of the source code file.

It will be appreciated by persons skilled in the art that embodiments of the invention are not limited by what has been particularly shown and described hereinabove. Rather the scope of at least one embodiment of the invention is defined by the claims below.

I claim:

1. A method comprising:
receiving a signal identifying a component shown on a display; and
identifying a file, said file comprising source code to generate said component.

2. The method as in claim 1, comprising opening said file; and displaying an editable version of said source code.

3. The method as in claim 1, said signal comprising a signal generated by a pointing device.

4. The method as in claim 1, comprising identifying a designation of another file, said another file comprising executable code generated from said source code.

5. The method as in claim 4, comprising changing said designation of said another file into a designation of said file comprising said source code.

6. The method as in claim 5, wherein said changing comprises changing a suffix of said designation of said another file.

7. The method as in claim 5, wherein said changing comprises changing a link of said designation of said another file.

8. The method as in claim 4, comprising searching a code base for said designation.

9. The method as in claim 1, comprising searching a table of a plurality of designations of files, said plurality of designations of files associated with a plurality of said components shown on said display.

10. The method as in claim 1, comprising identifying said file, said file associated with a parent of said component.

11. The method as in claim 1, comprising:
storing said file comprising said source code in a directory; and
storing another file comprising executable code generated by said source code in said directory.

12. The method as in claim 1, comprising:
freezing said component shown on said display; and
showing a selection menu on said display, said selection menu comprising:
a first choice, said first choice to open a file comprising said source code to generate said component; and
a second choice, said second choice to open a file comprising source code to generate a parent of said component.

13. The method as in claim 1, comprising displaying a link to said file.

14. A system comprising:
a display; and
a processor, said processor to
receive an electronic signal, said signal indicating a selection of a component shown on a display; and
open a file comprising an editable version of source code that controls said component.

15. The system as in claim 14, wherein said processor is to receive said signal generated by a pointing device.

16. The system as in claim 14, wherein said processor is to identify another file, said another file comprising executable code generated by said source code.

17. The system as in claim 16, wherein said processor is to alter a link of an address of said another file to convert an address of said another file into an address of said file comprising said source code.

18. The system as in claim 14, wherein said processor is to:
freeze said component shown on said display; and
show a selection menu on said display, said selection menu, comprising:
a first choice, said first choice to open said file comprising said source code to generate said component; and
comprising source code to generate a parent of said component.

19. An article comprising a storage medium, having stored thereon instructions, that when executed, result in opening a file comprising an editable version of source code that generates a component shown on a display, said opening in response to a selection by a user of said component.

20. The article as in claim 19, wherein said instructions further result in identifying another file, said another file comprising executable code generated by said source code.

21. The article as in claim 20, wherein said instructions further result in altering a class name of said another file, and deriving a name of said file comprising an editable version of said source code.

22. The article as in claim 20, wherein said instructions further result in searching a code base for a designation of said file comprising an editable version of said source code.
